(19) United States
(12) Patent Application Publication
(10) Pub. No.: US 2005/0195291 A1
(43) Pub. Date: Sep. 8, 2005

(54) Digital photography system and method of controlling photography

(75) Inventor: Masahiro Kubo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/052,821

(22) Filed: Feb. 9, 2005

(30) Foreign Application Priority Data
Mar. 4, 2004 (JP) 2004-061085

(51) Int. Cl. H04N 5/235; H04N 5/225

(52) U.S. Cl. 348/229.1; 348/207.11

(57) ABSTRACT

There is disclosed a photographic system, wherein a user designates photographic conditions of a digital still camera through a graphic user interface displayed on a monitor of a personal computer. The personal computer derives second photographic conditions from the photographic conditions designated by the user, and sets up the digital still camera with the second photographic conditions. Data of a still image taken under the second photographic conditions are sent from the digital still camera to the personal computer, to be processed for gradation compression and gradation conversion. The processed still image has similar gradation to that intended by the user in most brightness range, while white-saturation in a high brightness range and black-saturation in a low brightness range are reduced.

### FIELD OF THE INVENTION

The present invention relates to a digital photography system and a method of controlling photography, more particularly to a photography system which allows a user or photographer to take photographs while setting photographic conditions of a digital still camera appropriately through an external control device.

### BACKGROUND ARTS

Digital still cameras have been widely used, which photograph a subject through a solid state imaging device like a CCD image sensor, to take digital data of still images. Among these digital still cameras, a high-end model digital still camera, which is for professional and used for photographing persons and commercial articles in a studio, is connected to an external control device like a personal computer through a communication interface, e.g. IEEE1394, so that a user or operator of the personal computer sets up photographic conditions, such as aperture size and shutter speed, appropriately through the personal computer, and lets the still camera execute the photography through remote control. Still image data taken by this digital still camera are sent to the personal computer, to process the image data for example for correcting sharpness and color saturation, in accordance with the user's intention.

The solid state imaging device like a CCD image sensor generally has a disadvantage that its dynamic range is narrow in comparison with photographic film. The dynamic range is representative of a reproduction performance of luminance signals, i.e. a ratio of minimum to maximum values of representable luminance signals. Since photographers tend to set the exposure value with respect to the brightness of the main subject like a person, the photographed image tends to be too bright in its high-light portions. That is, pixels in a high brightness range are likely to be too light that they just look white regardless of their original colors. This phenomenon may be called white-saturation. After the photography, these white-saturated pixels are not correctable to restore original colors even by any image processing process.

### SUMMARY OF THE INVENTION

In view of the foregoing, a primary object of the present invention is to provide a digital photographic system and a method of controlling photography, which prevent the white-saturation in digital photography that use a digital still camera whose dynamic range is narrower than that of the photographic film.

Another object of the present invention is to provide a photographic system and a method of controlling photography, which prevent black-saturation. The black-saturation is a phenomenon where pixels in a low brightness range are not properly reproduced but just look black.

To achieve the above and other object, the present invention suggests a photographic system that comprises a digital still camera that takes still image data of a subject through photoelectric conversion of an optical image of the subject, and an external control device that is connected to the digital still camera and is operable by an operator, wherein first exposure conditions including at least one of aperture size and shutter speed are set in the external control device by the operator, and the external control device produces second exposure conditions based on the first exposure conditions, such that the second exposure conditions stop down exposure value as compared to the first exposure conditions. The external control device sends the second exposure conditions to the digital still camera for letting the digital still camera photograph under the second exposure conditions.

According to a preferred embodiment, the external control device receives still image data of a subject image photographed under the second conditions from the digital still camera, and carries out image processing on the still image data so as to make the subject image have a similar gradation curve in a middle brightness range to a subject image has, which would be obtained under the first exposure conditions.

According to the present invention, a photography control method for controlling a digital still camera, which takes still image data of a subject through photoelectric conversion of an optical image of the subject, by use of an external control device that is operable by an operator, comprises steps of:

setting first exposure conditions in the external control device by the operator, the first exposure conditions including at least one of aperture size and shutter speed; producing second exposure conditions in the external control device based on the first exposure conditions such that the second exposure conditions are adjusted to stop down exposure value as compared to the first exposure conditions; and sending the second exposure conditions to the digital still camera to let the digital still camera photograph under the second exposure conditions.

According to a preferred embodiment, the photography control method further comprises a step of processing still image data of a subject image as photographed under the second exposure conditions so as to have a similar gradation curve in a middle brightness range to a subject image has, which would be obtained under the first exposure conditions.

The processing preferably comprises hyper-tone processing for compressing high and low brightness ranges of low frequency brightness components extracted from the subject image, and gradation conversion processing for converting gradation of the subject image in accordance with predetermined gradation conversion conditions.

According to another preferred embodiment, the processing comprises gradation conversion processing for converting gradation of the subject image to have an S-shaped curve where gradients are suppressed in low and high brightness ranges but enhanced in a middle brightness range.

Because the second exposure conditions are adjusted to stop down the exposure value as compared to the first exposure conditions, the white-saturation is effectively prevented. Through the hyper-tone processing and the gradation conversion, or through the gradation conversion using the S-shaped curve, the obtained image data may be processed so that the subject image will have similar gradation to that would be obtained under the first exposure conditions, while reducing the white-saturation and the black-saturation.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is an explanatory diagram illustrating a photographic system according to an embodiment of the present invention;

FIG. 2 is a schematic block diagram of an external control device;

FIG. 3 is an explanatory diagram illustrating an example of a graphical user interface;

FIG. 4 is a schematic block diagram illustrating a hyper-tone processing program;

FIG. 5A is a graph illustrating an example of condition for gradation compression used for the hyper-tone processing;

FIG. 5B is a graph illustrating an example of brightness distribution curve used for the hyper-tone processing;

FIG. 6 is a graph illustrating an example of tone curve used for gradation conversion;

FIG. 7 is a flowchart illustrating an operation of the photographic system; and

FIG. 8 is a graph illustrating an S-shaped tone curve used for gradation conversion according to a second embodiment of the present invention.

### DESCRIPTION OF THE PREFERRED EMBODIMENTS

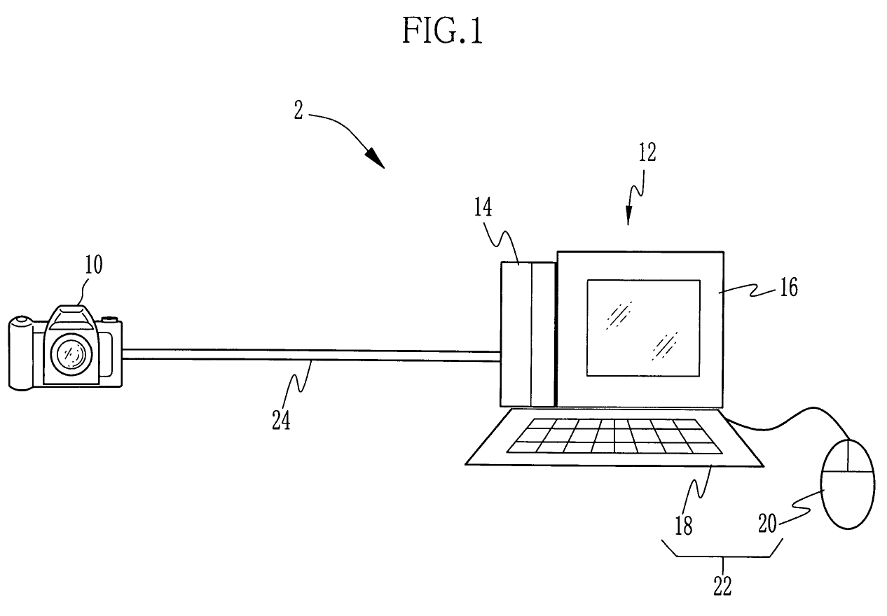

A photographic system 2 shown in FIG. 1 consists of a digital still camera 10 and a personal computer 12, which are connected to each other through a communication cable 24. The personal computer 12, which is installed with a control program for the digital still camera 10 and different kinds of image processing programs, consists of a main body 14, a monitor 16, and input devices 22, including a keyboard 18 and a mouse 20. Through the personal computer 12, a user can set photographic conditions of the digital still camera 10, like aperture size and shutter speed, and cause the digital still camera 10 to photograph under the set conditions, and also process data of photographed still images for gamma-correction, sharpness correction and the like.

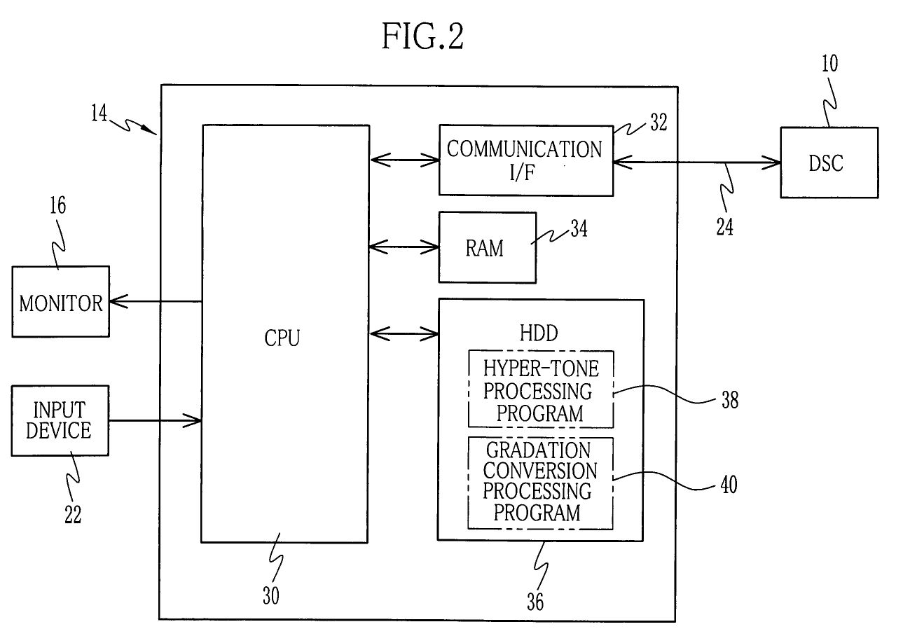

As FIG. 2 shows, the main body 14 of the personal computer 12 is constituted of a CPU 30, a communication interface 32, a RAM 34 and a hard disc drive (HDD) 36. The communication interface 32 is connected through the communication cable 24 to the digital still camera 10, to send the photographic conditions set by the user and control commands to the digital still camera 10, and receive the still image data from the digital still camera 10. The communication interface 32 may be any of known communication interfaces, such as RS-232C, USB and IEEE1394. The still image data from the digital still camera 10 may be of CCD-RAW data format that is obtained by converting analog signals, which are picked up by a CCD image sensor into digital signal through an A/D converter, or more versatile image file format, like JPEG or TIFF, that is obtained by converting the CCD-RAW data into the image file format inside the digital still camera 10.

The RAM 34 is a work memory that the CPU 30 uses for executing various processing programs. The HDD 36 stores the control program for controlling the digital still camera 10, the various image processing programs for processing the obtained still image data, and data of processed still images. For example, the image processing programs include a hyper-tone processing program 38 for compressing high-brightness and low-brightness ranges of low-frequency luminance component extracted from the still image, and a gradation conversion processing program 40 for converting gradation of the still image in accordance with preset conditions for the gradation conversion. The CPU 30 carries out these kinds of processing in response to user's commands that are input through the input devices 22.

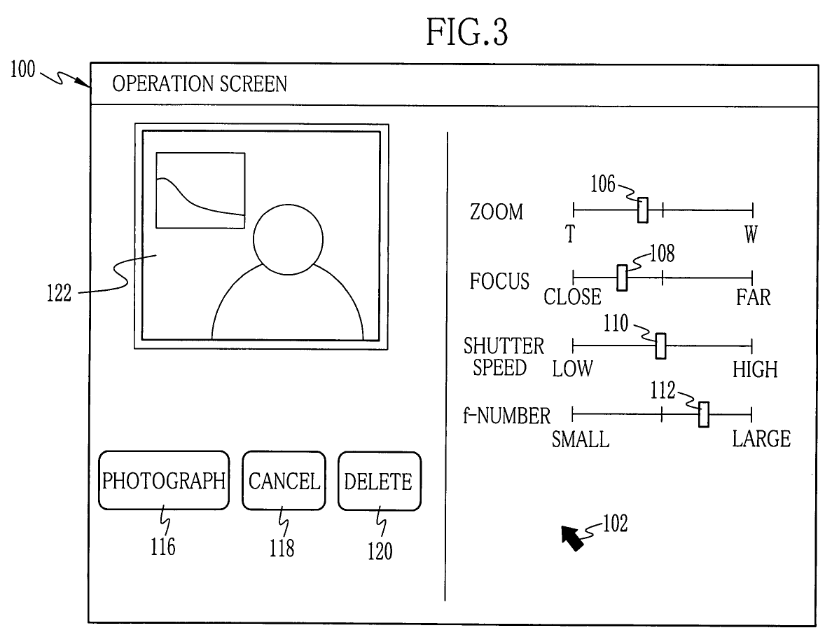

As shown in FIG. 3, the control program for controlling the digital still camera 10 adopts a graphical user interface (GUI) 100 that is displayed on the monitor 16, so that the user may enter commands by clicking or dragging the mouse 20 after placing a pointer 102 on an appropriate position on the monitor 16. The GUI 100 is provided with sliding bars 106, 108, 110 and 112 for allowing the user to set the photographic conditions of the digital still camera 10. In the illustrated embodiment, the photographic conditions to be set by the sliding bars 106 to 112 are zoom, focus, shutter speed and aperture size (f-number). But these are merely examples, and it is possible to add other photographic conditions.

When the user clicks on a photograph button 116 after setting the photographic conditions, hereinafter referred to as first exposure conditions, by the sliding bars 106 to 112, the CPU 30 produces photographic conditions, hereinafter referred to as second exposure conditions, on the basis of the first exposure conditions. The second exposure conditions are transferred to the digital still camera 10.

After being set to the second exposure conditions, the digital still camera 10 take a photograph to obtain still image data. The obtained still image data are transferred to the personal computer 12, and are subjected to the hyper-tone processing and the gradation conversion processing. The processed image data are stored in the HDD 36, and the photographed image is displayed on a view window 122.

The GUI 100 is also provided with a cancel button 118 and a delete button 120. The cancel button 118 is for resetting the photographic conditions to default values, and the delete button 120 is for deleting the obtained image if it is not desirable. Although the personal computer 12 is so-called desktop type in the illustrated embodiment, the personal computer 12 may be notebook type or tablet type. It is also possible to use a specific external control device with sliding switches or dial-type switches on a control panel, instead of the personal computer 12 with the graphical user interface (GUI).

As described above, because the CPU 30 adjusts the photographic conditions before setting them in the digital still camera 10, to make the exposure value smaller than that defined by the first exposure conditions set by the user, the photographed still image would have darker gradation than that the user expects. If the darker still image is merely displayed on the view window 122, the users may feel somewhat out of their expectation. For this reason, the obtained still image data are subjected to hyper-tone processing by the hyper-tone processing program 38 and gradation conversion processing by the gradation conversion processing program 40, whereby the still image has similar gradation to that would be obtained under the first exposure conditions, i.e. the photographic conditions set by the user, while minimizing the white-saturation.

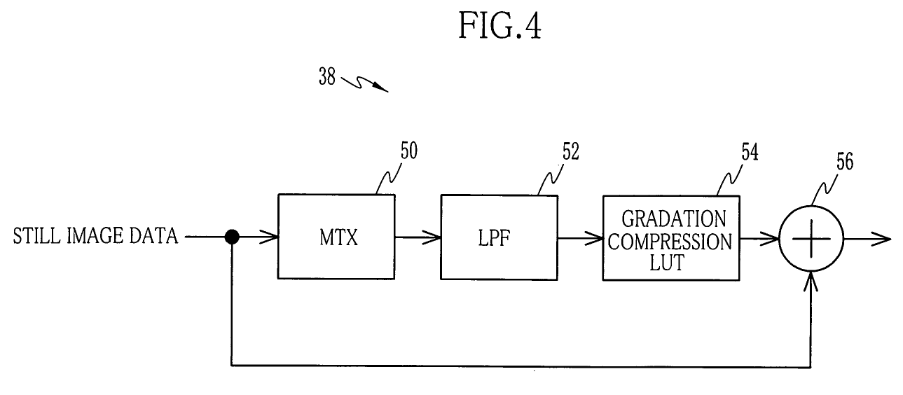

Referring to FIG. 4, the hyper-tone processing program 38 consists of a matrix operation (MTX) 50, a low-pass filter (LPF) 52, a gradation compression lookup table (LUT) 54 and an additive operating section 56. When the still image data is sent to the hyper-tone processing program 38, the MTX 50 calculates luminance components V, V=(red luminance component R+green luminance component G+blue luminance component B)/3, and extracts a high brightness range and a low brightness range from the still image data. The high brightness range will cause the white-saturation, whereas the low brightness range will cause the black-saturation. Next the low-pass filter 52 extract low frequency components of the luminance components V. The gradation compression LUT 54 compresses the low frequency component so as to lower its high brightness range and lift its low brightness range. Then the additive operating section 56 composes the gradation-compressed image data with the original still image data, thereby compressing gradation of the still image in the high brightness range and the low brightness range. These processes are called hyper-tone processing. Because the low frequency components alone are compressed, the hyper-tone processing permits compressing gradation without lowering the image quality. For example, if a back-lit human subject is photographed while adjusting the gradation to the human subject, its background like the sky will be white-saturated. Through the hyper-tone processing of the photographed image, its high frequency components, such as the face of the human subject, are maintained unchanged, while its low frequency components, such as the sky, are compressed. So the gradation of the still image is corrected adequately in view of the human subject and the background as well.

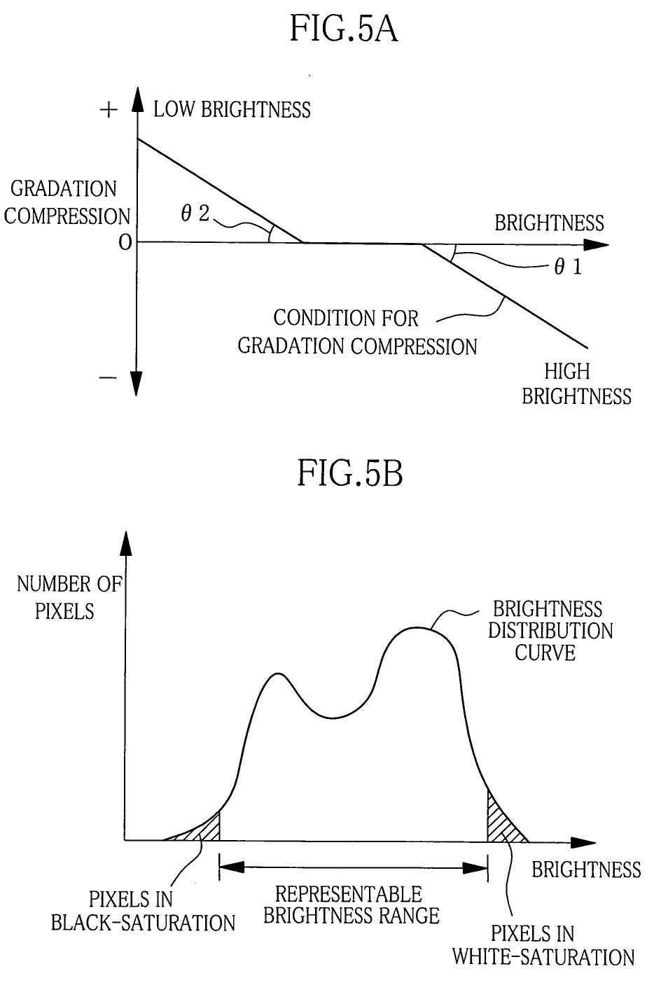

The conditions for gradation compression in the gradation compression LUT 54 are defined in the following manner. In the following example, a basic pattern shown in FIG. 5A is prepared for the gradation compression conditions. As parameters in the basic pattern, there are an inclination θ1 that defines a condition for gradation compression in the high brightness range of the image and an inclination θ2 that defines a condition for gradation compression in the low brightness range of the image.

The conditions for gradation compression in the hyper-tone processing define a representable brightness range with reference to a center brightness of a brightness distribution curve of the still image data, as shown for example in FIG. 5B. Thereafter, the numbers of those pixels which are outside the defined brightness range, i.e. ones which will suffer the white-saturation or the black-saturation, are calculated respectively with respect to the high brightness range and the low brightness range. Then the above mentioned inclinations θ1 and θ2 are determined such that the degree of compression increases as the number of irreproducible pixels increases. In other words, the inclinations θ1 and θ2 are determined so as to limit the brightness distribution curve of the still image data to the representable brightness range. This way, the gradation compression conditions are determined in accordance with the contents of the still image data, and the gradation compression LUT 54 compresses the gradation of the still image data under these gradation compression conditions.

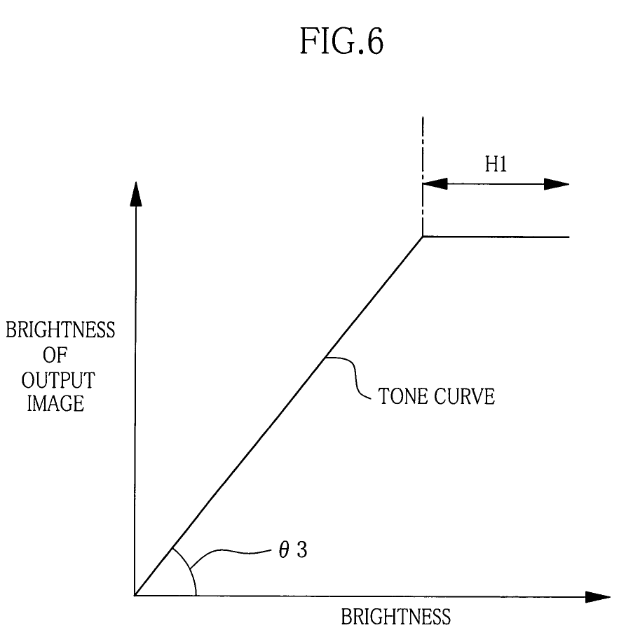

The gradation conversion processing program 40 converts the gradation of the still image data by use of a tone curve as shown in FIG. 6, one of the gradation conversion conditions. By adjusting an inclination θ3 according to the exposure value determined by the CPU 30, the gradation is converted to be correspondent to the exposure value designated by the user. In the tone curve of FIG. 6, a range designated by an arrow H1 shows that the output brightness is saturated in this range in spite of any increase in the input brightness. Accordingly, the above-mentioned hyper-tone program 38 compresses this range H1, to obtain an image that has similar gradation to that would be obtained under the photographic conditions intended by the user, while reducing the white-saturation and the black-saturation.

As described so far, after being subjected to the hyper-tone processing and the gradation conversion, the still image data having its gradation adjusted to the user's intension, are stored in designated locations in the HDD 36. At the same time, the converted still image is displayed on the view window 122.

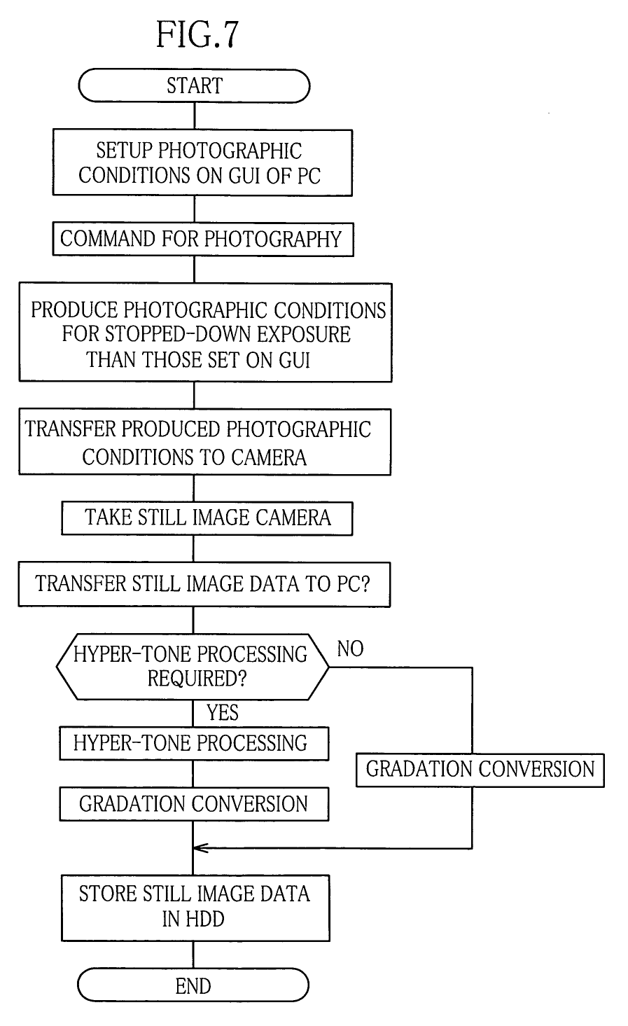

Now the operation of the above configuration will be described with reference to the flowchart of FIG. 7.

When the personal computer 12 is set up as shown in FIG. 1 and receives a command for starting the control program, the personal computer 12 displays a graphical user interface like the GUI 100 as shown in FIG. 3 on the monitor 16, so that the user may set photographic conditions on the digital still camera 10 by operating the sliding bars 106 to 112 on the GUI 100. When the user clicks on the photograph button 116 after setting appropriate photographic conditions, the CPU 30 produces the second exposure conditions based on the photographic conditions set through the sliding bars 106 to 112, i.e. the first exposure conditions. The second exposure conditions are adjusted to stop down the exposure value so as to prevent the white-saturation. The CPU 30 transfers the second exposure conditions to the digital still camera 10. After being set to the transferred conditions, the digital still camera 10 photographs a still image to get data of the still image, and sends the still image data to the personal computer 12.

Upon receipt of the still image data through the communication interface 32, the CPU 30 activates the hyper-tone processing program 38. Then, the MTX 50 calculates the luminance components V of the still image data, and extracts the high brightness range and the low brightness range from the still image data. If the width from the extracted high to low brightness ranges is within the representable brightness range, the still image data is written on the RAM 34 without being subjected to the hyper-tone processing. If the width from the extracted high to low brightness ranges extend over the representable brightness range, the still image data is subjected to the hyper-tone processing and thereafter written on the RAM 34.

After confirming the end of the hyper-tone processing in the hyper-tone processing program 38, the CPU 30 activates the gradation conversion processing program 40 and subjects the still image data as being written on the RAM 34 to the gradation conversion processing program 40. The gradation conversion processing program 40 converts the gradation of the still image data on the basis of the designated tone curve, to remake the gradation in accordance with the photographic conditions intended by the user. The processed still image data are stored in the HDD 36, and a corresponding image is displayed on the view window 122.

If the image displayed on the view window 122 looks undesirable or unexpected, the user clicks on the delete button 120 to delete the stored still image data, or activates another image processing program to process the image in other ways, for example, for sharpness correction or saturation correction. These image processing programs may be combined with the control program for the digital still camera 10, so that they may be executed on a graphic user interface (GUI).

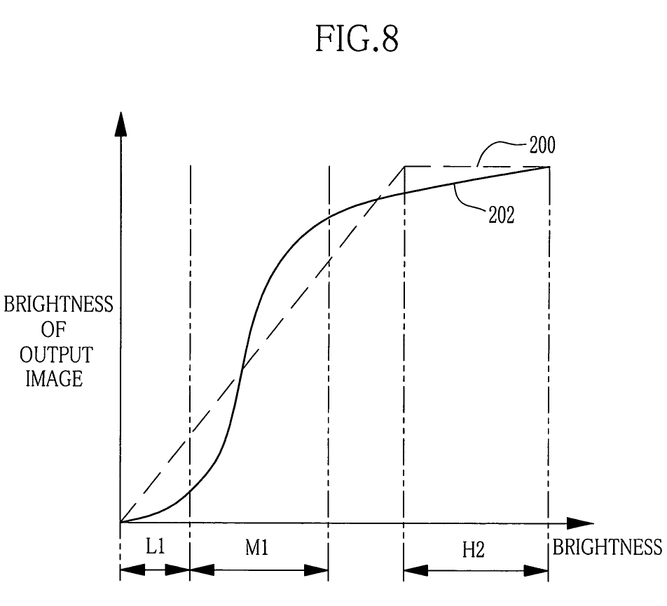

Instead of making gradation compression through the above-described hyper-tone processing, it is possible to make gradation conversion through an S-shaped tone curve shown in FIG. 8. According to a straight-linear tone curve 200, the output will be saturated in a high brightness range designated by an arrow H2. On the other hand, the S-shaped tone curve 202 has gradients even in the high brightness range H2. In addition to that, because the curve 202 is steeper in a middle brightness range M1 that is necessary for most main subjects, such as a human subject, the output image will get more gradation levels in the middle brightness range in comparison with the tone curve 200. In a low brightness range designated by an arrow L1, dark current through the CCD image sensor will cause a noise, so-called shadow noise. The S-shaped tone curve 202, on the contrary, is more gradual than the tone curve 200 in the low brightness range L1, so the shadow noise is reduced.

It is possible to provide the digital still camera 10 with a lookup table that corresponds to the S-shaped tone curve 202, so that the digital still camera 10 transfer still image data to the personal computer 12 after converting the gradation of the still image data.

In both of the first and second embodiments, the amount of adjusting the exposure value by the CPU 30 may be defined by adding a constant amount of adjustment to the value set by the user, or by adding a variable amount of adjustment, like the tone curve for the gradation conversion, to the value set by the user. It is also possible to analyze the white-saturation or the black-saturation from the luminance components V obtained by the MTX 50, on the basis of reference still image data obtained through a test photograph, so as to calculate adequate exposure conditions. The calculated exposure conditions may be reported to the user, for example by displaying them on the monitor 16. Then the user can refer to these conditions for taking photographs by use of the digital still camera 10 alone.

If the still image obtained from the test photograph suffers white-saturation or black-saturation, those pixels whose colors are saturated white or black may be converted to have a conspicuous color, such as primary green or primary red, so that the user may notice them. Then the user can change the photographic conditions appropriately.

Although the present invention has been described with respect to the preferred embodiments, the present invention is not to be limited to the above embodiments but, on the contrary, various modifications will be possible without departing from the scope of claims appended hereto.

1. A photographic system comprising a digital still camera that takes still image data of a subject through photoelectric conversion of an optical image of said subject, and an external control device that is connected to said digital still camera and is operable by an operator, wherein first exposure conditions including at least one of aperture size and shutter speed are set in said external control device by the operator, and said external control device produces second exposure conditions based on said first exposure conditions, such that said second exposure conditions stop down exposure value as compared to said first exposure conditions, and sends said second exposure conditions to said digital still camera for letting said digital still camera photograph under said second exposure conditions.

2. A photographic system as claimed in claim 1, wherein said external control device receives still image data of a subject image photographed under said second conditions from said digital still camera, and carries out image processing on said still image data so as to make said subject image have a similar gradation curve in a middle brightness range to a subject image has, which would be obtained under said first exposure conditions.

3. A photographic system as claimed in claim 2, wherein said external control device is connected through a communication cable to said digital still camera.

4. A photographic system as claimed in claim 2, wherein said image processing comprises hyper-tone processing for compressing high and low brightness ranges of low frequency brightness components extracted from said subject image, and gradation conversion processing for converting gradation of said subject image in accordance with predetermined gradation conversion conditions.

5. A photographic system as claimed in claim 2, wherein said image processing comprises gradation conversion processing for converting gradation of said subject image to have an S-shaped curve where gradients are suppressed in low and high brightness ranges but enhanced in a middle brightness range.

6. A photographic system as claimed in claim 1, wherein said digital still camera subjects said still image data to gradation conversion processing for making gradation of said subject image as photographed under said second exposure conditions have an S-shaped curve where gradients are suppressed in low and high brightness ranges but enhanced in a middle brightness range, such that said subject image has a similar gradation curve in said middle brightness range to a subject image as photographed under said first exposure condition would have.

7. A photography control method for controlling a digital still camera by use of an external control device that is operable by an operator, said digital still camera taking still image data of a subject through photoelectric conversion of an optical image of said subject, said photography control method comprising steps of:
setting first exposure conditions in said external control device by the operator, said first exposure conditions including at least one of aperture size and shutter speed; producing second exposure conditions in said external control device based on said first exposure conditions such that said second exposure conditions are adjusted to stop down exposure value as compared to said first exposure conditions; and
sending said second exposure conditions to said digital still camera to let said digital still camera photograph under said second exposure conditions.

8. A photography control method as claimed in claim 7, further comprising step of processing still image data of a subject image as photographed under said second exposure conditions so as to have a similar gradation curve in a middle brightness range to a subject image has, which would be obtained under said first exposure conditions.

9. A photography control method as claimed in claim 8, wherein said processing comprises hyper-tone processing for compressing high and low brightness ranges of low frequency brightness components extracted from said subject image, and gradation conversion processing for converting gradation of said subject image in accordance with predetermined gradation conversion conditions.

10. A photography control method as claimed in claim 8, wherein said processing comprises gradation conversion processing for converting gradation of said subject image to have an S-shaped curve where gradients are suppressed in low and high brightness ranges but enhanced in a middle brightness range.
